(19) United States
(12) Patent Application Publication
(10) Pub. No.: US 2014/0231170 A1
(43) Pub. Date: Aug. 21, 2014

(54) STEP SENSOR AND LADDER HAVING SAME

(71) Applicants: William Frame, Parkesburg, PA (US); John Sayles, West Chester, PA (US)

(72) Inventors: William Frame, Parkesburg, PA (US); John Sayles, West Chester, PA (US)

(21) Appl. No.: 14/181,186

(22) Filed: Feb. 14, 2014

Related U.S. Application Data
(60) Provisional application No. 61/764,698, filed on Feb. 14, 2013.

(51) Int. Cl. E06C 7/00; G01S 17/02

(52) U.S. Cl. CPC E06C 7/003; G01S 17/02
USPC 182/18; 250/338.1; 250/347

(57) ABSTRACT

A step sensor for mounting on a ladder having a step. The step sensor adapted to be mounted to the ladder. The step sensor includes a housing that holds a power source and electronic circuitry. An emitter is connected to the electronic circuitry and emits a light source over a top surface of the step. A sensor is also connected to the electronic circuitry and receives reflected light from the light source that is reflected by an object on the step. A noise generator generates an alert noise in response to the reflected light being detected by the light sensor, whereby the presence of an object is detected on the step and the alert is generated by the noise generator. A ladder including such a step sensor.

### CROSS-REFERENCE TO RELATED APPLICATIONS

This application claims priority to U.S. Provisional Pat. Application 61/764,698 filed on Feb. 14, 2013.

### STATEMENT REGARDING FEDERALLY SPONSORED RESEARCH OR DEVELOPMENT

The present invention was not developed with the use of any Federal

Funds, but was developed independently by the inventor.

### BACKGROUND

### Field

The invention relates to a step sensor for detecting the presence of an object, such as a user's foot, on the step of a ladder and generating an alert.

### SUMMARY

A step sensor for mounting on a ladder having a step. The step sensor adapted to be mounted to the ladder. The step sensor includes a housing that holds a power source and electronic circuitry. An emitter is connected to the electronic circuitry and emits a light source over a top surface of the step. A sensor is also connected to the electronic circuitry and receives reflected light from the light source that is reflected by an object on the step. A noise generator generates an alert noise in response to the reflected light being detected by the light sensor, whereby the presence of an object is detected on the step and the alert is generated by the noise generator. A ladder including such a step sensor.

The power source may be a battery. The sensor may detect a level of infrared light returned to the step sensor and if the level of infrared light is above a calibrated threshold, the alert noise is triggered by the noise generator. The alert can be a noise, a prerecorded voice, or a sound alert and the noise generator is a buzzer or speaker.

The step sensor may comprise an IR filter to reduce the effects of visible light on the sensor. The step sensor comprise a flat back drop mounted on the opposite rail than that the sensor is mounted to provide a uniform background for the sensor. The step sensor may comprising a first lens on the emitter to focus the IR light only over the top surface of the step and a second lens on the receiver to focus its sensitivity only on the area over the step and/or to increase its range. The light source may emit IR, visible light, ultrasonic waves, or laser light.

The step sensor may include a flexible mounting for mounting the sensor on the ladder between rails of the ladder to make the step sensor unobtrusive.

The step sensor may include an algorithm to minimize the false detection of an object on the step including ambient light cancellation and calibration for a specific ladder on which the step sensor is installed.

### BRIEF DESCRIPTION OF THE DRAWINGS

The embodiments will be described in detail with reference to the following drawings in which like reference numerals refer to like elements wherein:

FIG. 1 shows a step sensor in accordance with the present invention.

FIG. 2 shows the step sensor of FIG. 1 mounted to a ladder.

### DETAILED DESCRIPTION

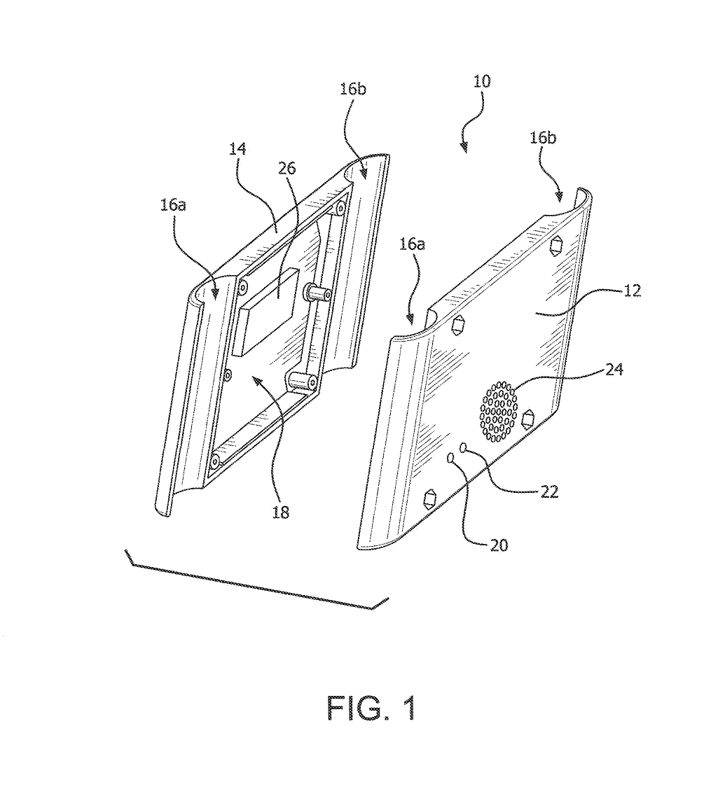

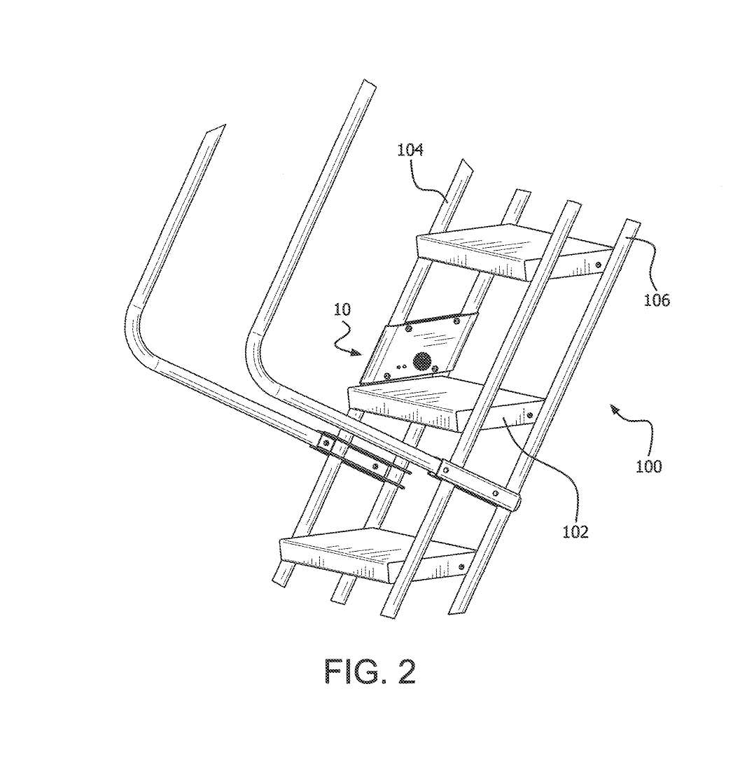

Referring now to the FIGS. 1 and 2, the present invention comprises a step sensor 10. The step sensor 10 comprises a housing having a front 12 and a back 14. Formed at the lateral ends of the front 12 and back 14 housing portions are tubular channels 16a and 16b for attaching the step sensor to a ladder 100. Preferably, the sensor is mounted to the stringer rails of the ladder 100 so as to be located above a top surface of a step 102, as best seen in FIG. 2.

The step sensor 10 includes a battery and electronics compartment 18 disposed within the housing portions 12 and 14 and is container therein for holding the electronics and circuit board(s) 26 of the sensor 10. The sensor 10 also includes a light emitter 20 and a light sensor 22. A speaker or buzzer 24 is also provided, as described in greater detail below.

The sensor 10 uses an infraredlight source from emitter 20 and a light sensor 22 to detect the presence of an object, such as a user's foot, on the step 102. A pulse of infrared light is emitted by the emitter 20 over the top surface of the step 102. The sensor 22 detects the level of infrared light returned to the step sensor 10. If the amount is above a calibrated threshold, an alert is triggered.

The alert can be a noise, such as a prerecorded voice, a sound alert, or the like, generated by the buzzer or speaker 24. The sound may be updated using a USB port (not shown) connected to the circuit board 26 and a memory provided on the circuit board 26 in the sensor 10.

The sensor is powered by a portable energy source, such as batteries, preferably 3 AA batteries, possibly rechargeable batteries. The life of the battery is maximized by pulsing the IR emitter 20 and using a very low power sensor 22 and processor on board 26 to control the sensor 10. If rechargeable batteries are used, they could be recharged using the USB port.

Various algorithms are used to minimize the false detection of an object on the step including ambient light cancellation and calibration for the specific ladder on which it is installed. The emitter 20 uses a lens to focus the IR light only over the top surface of the step 102 (also to reduce false detections). A lens may also be used on the receiver 22 to focus its sensitivity only on the area over the step 102 and/or to increase its range.

An IR filter disposed on sensor 22 may be used to reduce the effects of visible light on the sensor 22. A flat back drop may be used on the opposite rail to provide a uniform background for the sensor 22.

The sensor package is such that it can be mounted on the ladder 100 between the rails 104 and 106 making it unobtrusive. The step sensor 10 includes a flexible mounting, such as channels 16a and 16b, to allow it to be installed on a variety of ladder styles. A particular configuration will allow it to be mounted on the inside of a rail on an A-frame ladder. The rags on an A-frame ladder are a single C-channel, whereas the rails on a rolling ladder are a pair of tubes on each side of the step.

An indicator may be provided to alert of a low battery reserve condition.

Other than IR technology, visible light (using a backdrop and looking for a change in light), ultrasonic (similar to the lift sensor) and laser could all be used for the same function.

Any reference in this specification to “one embodiment,” “an embodiment,” “example embodiment,” and the like, means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A step sensor adapted to be mounted on a ladder having a step, the step sensor comprising:
a housing that holds a power source and electronic circuitry;
an emitter connected to the electronic circuitry, the emitter emits a light source over a top surface of the step and a sensor connected to the electronic circuitry, the sensor receives reflected light from the light source that is reflected by an object on the step;
a noise generator that generates an alert noise in response to the reflected light being detected by the light sensor, whereby the presence of an object is detected on the step and the alert is generated by the noise generator.

2. The step sensor according to claim 1 wherein the power source is a battery.

3. The step sensor according to claim 1 wherein the sensor detects a level of infrared light returned to the step sensor and if the level of infrared light is above a calibrated threshold, the alert noise is triggered by the noise generator.

4. The step sensor according to claim 1 further comprising an IR filter to reduce the effects of visible light on the sensor.

5. The step sensor according to claim 1 further comprising a flat back drop mounted on the opposite rail than that the sensor is mounted to provide a uniform background for the sensor.

6. The step sensor according to claim 1 further comprising a first lens on the emitter to focus the IR light only over the top surface of the step and a second lens on the receiver to focus its sensitivity only on the area over the step and/or to increase its range.

7. The step sensor according to claim 1 wherein the alert can be a noise, a prerecorded voice, or a sound alert and the noise generator is a buzzer or speaker.

8. The step sensor according to claim 1 wherein the light source emits IR, visible light, ultrasonic waves, or laser light.

9. The step sensor according to claim 1 further comprising a flexible mounting for mounting the sensor on the ladder between rails of the ladder to make the step sensor unobtrusive.

10. The step sensor according to claim 1 wherein an algorithm is used to minimize the false detection of an object on the step including ambient light cancellation and calibration for a specific ladder on which the step sensor is installed.

11. A ladder, the ladder having a step, the ladder comprising:
a step sensor adapted to be mounted thereto, the step sensor comprising:
a housing that holds a power source and electronic circuitry;
an emitter connected to the electronic circuitry, the emitter emits a light source over a top surface of the step and a sensor connected to the electronic circuitry, the sensor receives reflected light from the light source that is reflected by an object on the step:
a noise generator that generates an alert noise in response to the reflected light being detected by the light sensor, whereby the presence of an object is detected on the step and the alert is generated by the noise generator.

12. The ladder according to claim 11 wherein the power source is a battery.

13. The ladder according to claim 11 wherein the sensor detects a level of infrared light returned to the step sensor and if the level of infrared light is above a calibrated threshold, the alert noise is triggered by the noise generator.

14. The ladder according to claim 11 further comprising an IR filter to reduce the effects of visible light on the sensor.

15. The ladder according to claim 11 further comprising a flat back drop mounted on the opposite rail than that the sensor is mounted to provide a uniform background for the sensor.

16. The ladder according to claim 11 further comprising a first lens on the emitter to focus the IR light only over the top surface of the step and a second lens on the receiver to focus its sensitivity only on the area over the step and/or to increase its range.

17. The ladder according to claim 11 wherein the alert can be a noise, a prerecorded voice, or a sound alert and the noise generator is a buzzer or speaker.

18. The ladder according to claim 11 wherein the light source emits IR, visible light, ultrasonic waves, or laser light.

19. The ladder according to claim 11 further comprising a flexible mounting for mounting the sensor on the ladder between rails of the ladder to make the step sensor unobtrusive.

20. The ladder according to claim 11 wherein an algorithm is used to minimize the false detection of an object on the step including ambient light cancellation and calibration for a specific ladder on which the step sensor is installed.
